(19) United States
(12) Patent Application Publication
(10) Pub. No.: US 2012/0159429 A1
(43) Pub. Date: Jun. 21, 2012

(54) METADATA BASED EVENTING

(75) Inventors: Peter Villadsen, Sammamish, WA (US); Zhaoqi Chen, Bellevue, WA (US); Marcos Calderon Macias, Seattle, WA (US); Ramakanthachary Gottumukkala, Sammamish, WA (US)

(73) Assignee: MICROSOFT CORPORATION, Redmond, WA (US)

(21) Appl. No.: 12/968,434

(22) Filed: Dec. 15, 2010

(51) Int. Cl. G06F 9/44

(52) U.S. Cl. 717/106

(57) ABSTRACT

Customization of software source code is enabled by adding the event handlers to be invoked in metadata instead of as coding artifacts. The fact that classes offer delegates that can be assigned handlers is described as part of metadata, in other words, as descriptions of the event itself. By defining eventing in metadata, adding and/or removing handlers for specific events is enabled without programming or modification of the source code.

### BACKGROUND

Event-driven programming is a programming paradigm, where the flow of the program is determined by events inputs, user actions, or messages from other programs or threads. In event-driven application architecture, an application has a main loop that is divided into two sections: event detection and event handling. In some integrated development environments code generation assistants may automate some repetitive tasks required for event handling.

An event-driven program comprises a series of subroutines or methods, also called event-handler routines. These methods handle the events to which the main program responds. For example, a user input (e.g., keyboard entry, mouse click, etc.) may trigger a method to open or close a window that is part of a user interface, save data, exit the application, and comparable actions. Event handlers are bound to events so that the correct function is called when the event occurs. User actions cause the program to raise events and call the matching event handler(s) to process the events.

Business applications are complex software with potentially thousands of methods and event handlers and involve typically in-depth research, large amounts of code, extensive testing, etc. When it comes to customization of complex software like a business application, designers may either provide a limited number of default alternatives, which may restrict user experience, or provide access to the entire code for developers of custom code. When a large portion or the entire code of a software application is accessible, however, the original developers lose control over characteristics of the program. Changes made by various developers may invalidate any testing performed on the original program, unexpected faults or execution results may occur over which the original developers have no control. Thus, opening the code may have unintended results that defeat the purpose of the program (e.g., user satisfaction, performance, suitability for solving problems in a particular problem domain, etc.).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to customization of software source code by adding the event handlers to be invoked in metadata instead of as coding artifacts. According to some embodiments, the fact that classes offer delegates that can be assigned handlers is described as part of metadata, in other words, as descriptions of the event itself. By defining eventing in metadata, adding and/or removing handlers for specific events is enabled without programming, i.e., modification of the source code.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating example methods and handlers in a software environment;

FIG. 2 illustrates an example metadata model according to some embodiments;

FIG. 3 illustrates an event node with handlers and properties on an example user interface for code development according to some embodiments;

FIG. 4 illustrates a context menu for adding handlers to an event on an example user interface for code development according to other embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of metadata based eventing according to embodiments.

### DETAILED DESCRIPTION

As briefly described above, software source code may be customized without modifying the code itself by adding event handlers to be invoked in metadata instead of as coding artifacts. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for executing applications, where embodiments may be implemented. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. While business applications are used as examples of software for implementing handlers in metadata for customizing programs without modifying source code, embodiments may be implemented in any type of application. More detail on these technologies and example operations is provided below.

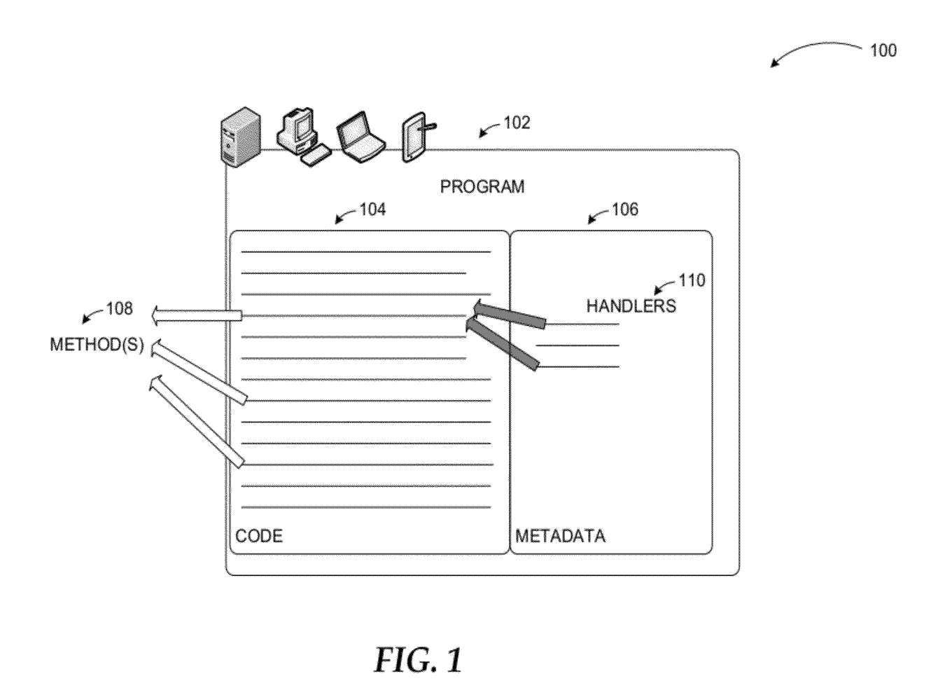

FIG. 1 includes conceptual diagram 100 illustrating example methods and handlers in a software environment. In its basic form, source code may include statements, declarations, methods, operators, and keywords. In object-oriented programming, a class is a construct that is used as a template to create objects of that class. The class encapsulates a state and behavior of the concept it represents. It encapsulates the state through data placeholders called attributes and behavior through methods. A method is a subroutine that is associated either with a class, in which case it is called a class method or a static method, or with an object, in which case it is an instance method. A method usually comprises a sequence of programming statements to perform an action, a set of input parameters to customize those actions, and possibly one or more output values (also called the return value(s)). Methods provide a mechanism for accessing and processing specified portions of data.

A software customization system according to embodiments enables customization of complex software through metadata based eventing without modification of the source code 104 of a software program 102, which may be executed by a server, a desktop computer, a laptop computer, a handheld computer, a vehicle-mount computer, a smart phone, and comparable computing devices. As discussed above, source code 104 includes a number of methods 108. In a system according to embodiments, classes offer delegates that can be assigned handlers 110 as part of metadata 106. By defining eventing in metadata 106, handlers 110 for specific events (or methods 108) may be added or removed without modifying the source code 104.

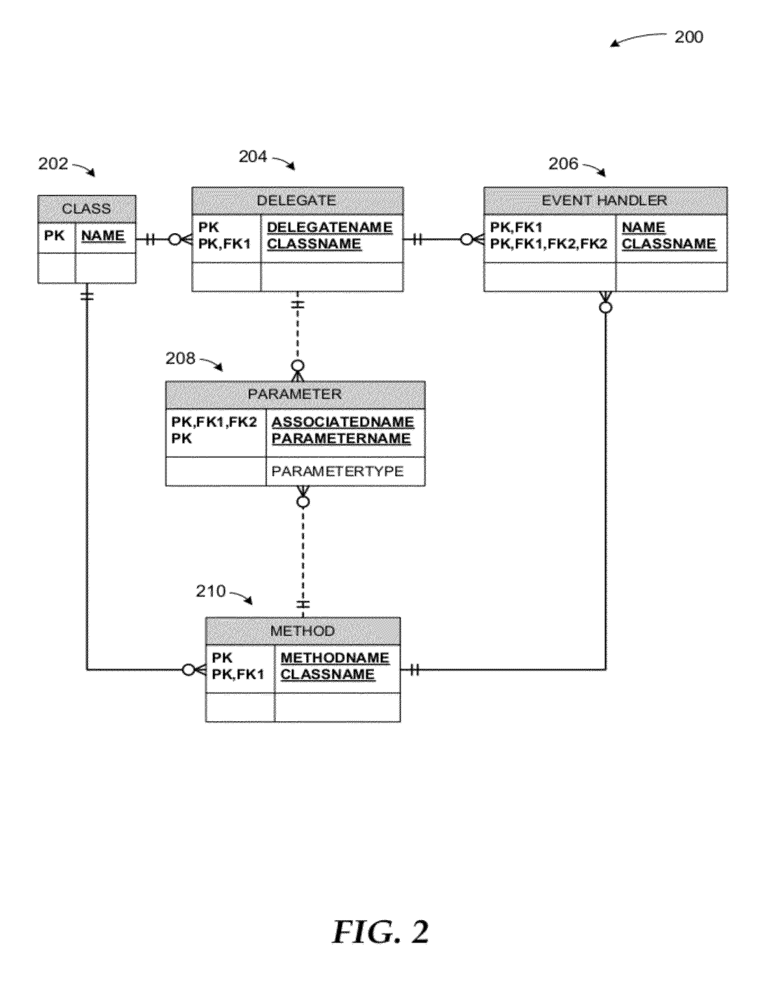

FIG. 2 illustrates an example metadata model according to some embodiments. A system according to embodiments follows publish and subscribe model, where the customizable code publishes information that any number of interested parties (i.e., the custom code) can subscribe to. The customizing code is, thus, loosely coupled to the code implementing the functionality that is customized. The underlying implementation can thereby change freely (without breaking customizing code), as long as the event is fired under similar situations.

An event is a programming artifact that signals a change in the state of the application code. Subscribers may be notified when the event is raised. A subscription is a contract that exists between an event and an event handler. The subscription may cause an event handler to be called whenever the event is raised. The event handler, in a system according to embodiments, is a piece of code that has manifested an interest in being notified when an event is raised (subscription). Each event may have any number of event handlers assigned to it.

A system according to embodiments may employ a number of types of events, which may include a business event, which is modeled in the application metadata and can be raised whenever the application determines it is relevant to inform interested parties (i.e., the subscribers) of an interesting point in the business logic execution. Each method may have a designated set of (formal) parameters. These may be considered as variables that are initialized with the value of the actual parameter prior to the execution of the method. A delegate is a type of an event that defines a parameter profile to be matched by individual handlers.

As shown in diagram 200, class 202 is uniquely identified by its name. Class 202 may have any number (including zero) of delegates 204, and any number (including zero) of methods 210. Delegates 204 and methods 210 may have any number (including zero) of named parameters 208 of a particular type. Delegate 204 may have any number (including zero) of event handlers 206 that are called when the event is raised. Each handler 206 is a method on a particular class (202).

According to an example scenario, an application developer who authored the code to be customized may designate some delegates as extension/customization points. A customizing developer may then customize the program by providing event handlers to these delegates, which means that modification of the existing source code is not needed for implementation of the customization.

For example, the customizing developer may install a new version of the source (with the extension/customization points maintained) and then install the customization layer on top of the new version. Because the custom code does not rely on the implementation of the underlying layer (which may have been extensively changed from the old version) but merely reacts to events raised from the application layer, the upgrade involves mainly setting up the metadata to indicate that the customization methods should be called.

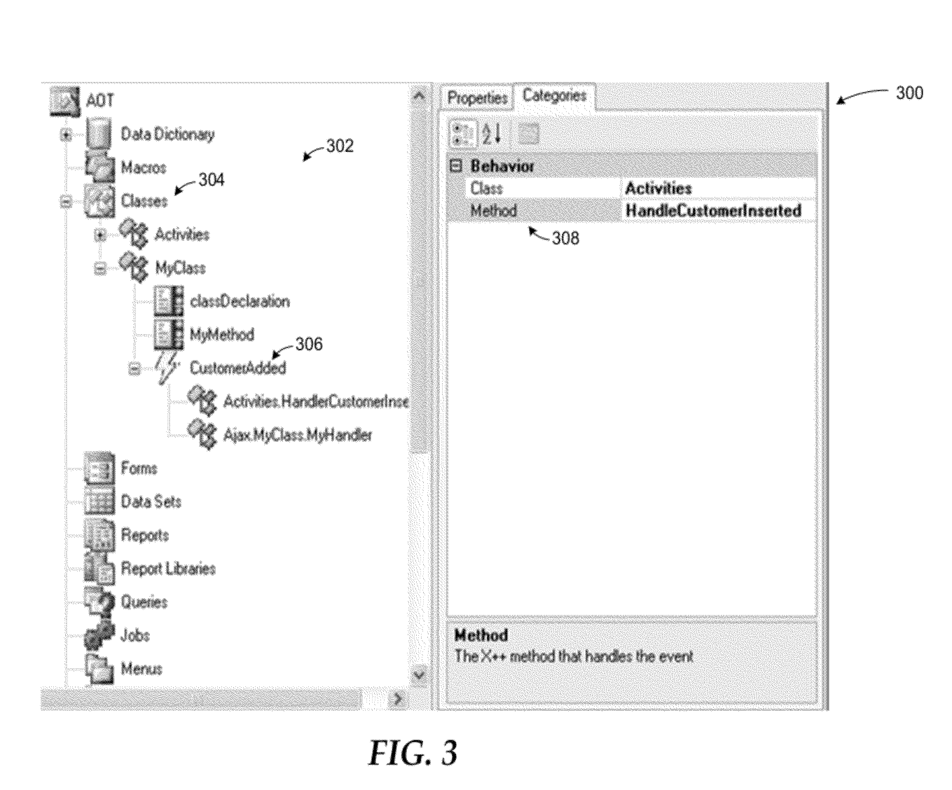

FIG. 3 illustrates an event node with handlers and properties on an example user interface 300 for code development according to some embodiments. As mentioned previously, delegates are a named type profile that is to be matched by the handlers for an event; a class can have any number of events; and each event is like a method, but it has no body (its main payload is the parameter profile, and the list of event handlers to call when the event happens).

In a system according to embodiments, the methods may appear in the “classes” node 304. The events may be listed as a separate set of methods (e.g., “CustomerAdded” 306) and be designated with a special icon to indicate that they are events, not normal methods. In an example code development user interface 300, each of the nodes representing an event may be a list node, under which the user can add event handlers employing drag/drop and context menu operations. When a method is selected, its behavior, properties, etc. may be presented in a separate user interface portion (308) to enable developers view details associated with the selected method and modify these.

The events may be accessible within the class. In other words, they may be protected, according to some embodiments. The metadata may be represented as nodes with properties in the user interface 300. The metadata nodes may be saved and retrieved from the metadata database, support importing and exporting, support context menu items, etc. According to other embodiments, metadata may support versioning such that upgrades are efficiently enabled if the property set changes.

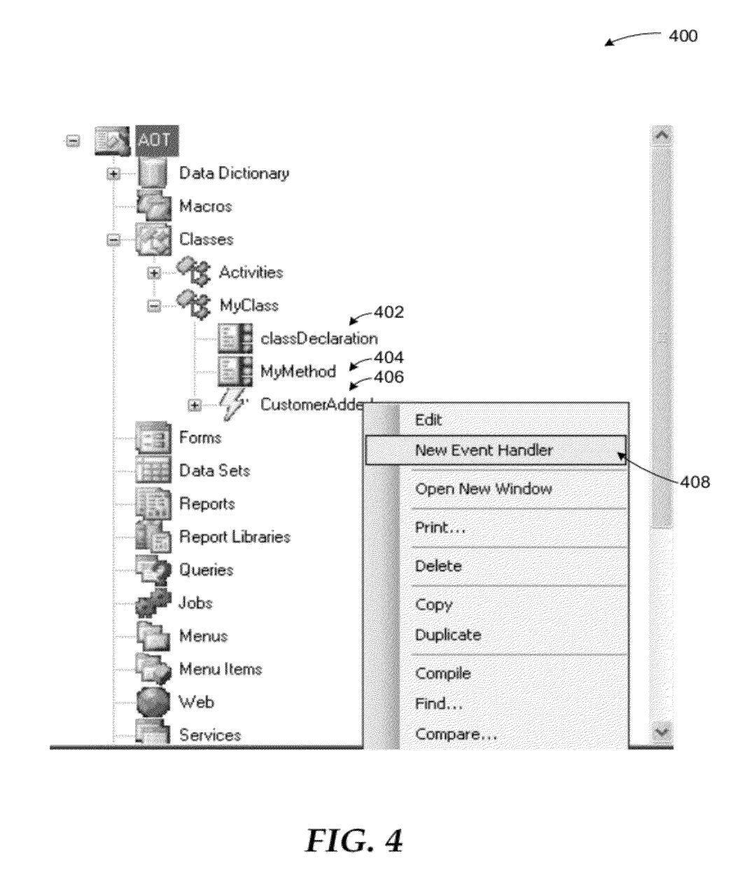

FIG. 4 illustrates a context menu for adding handlers to an event on an example user interface for code development. Each delegate under the class node described above may have a sequence of event handlers beneath it that are called when the event is raised. Each delegate may also have a name property that is unique within the list of methods and events. The name may be maintained in the same way as method names are maintained. Delegates, like ordinary methods, may be name based. The label of each event may be its name.

According to further embodiments, the delegates may be subject to the same developer documentation (e.g., XML comments) as normal methods. Developers determine from this documentation under which circumstances an event is raised and the meaning of the individual parameters.

When a delegate is selected under the “Classes” node 402, a context menu 404 may be presented enabling various actions associated with the delegate. For example, it may be possible to delete delegate nodes, either by selecting the Delete item in the context menu 404. Of course, a variety of other interaction options such as use of keyboard entries, etc. may also be provided. If a delegate node is deleted, all references to its children (i.e. the individual handlers) may also be deleted. Similarly, new event handlers may be added to the metadata through the context menu (e.g., using the “New Event Handler” item 406).

The delegate node may contain any number of child nodes designating handlers for the event. The different types of handlers may be indicated with different icons on user interface 400 to reflect how they are handled.

The configurations and implementations of metadata based eventing discussed above are for illustration purposes and do not constitute a limitation on embodiments. Embodiments may be implemented employing other modules, processes, and configurations using the principles discussed herein.

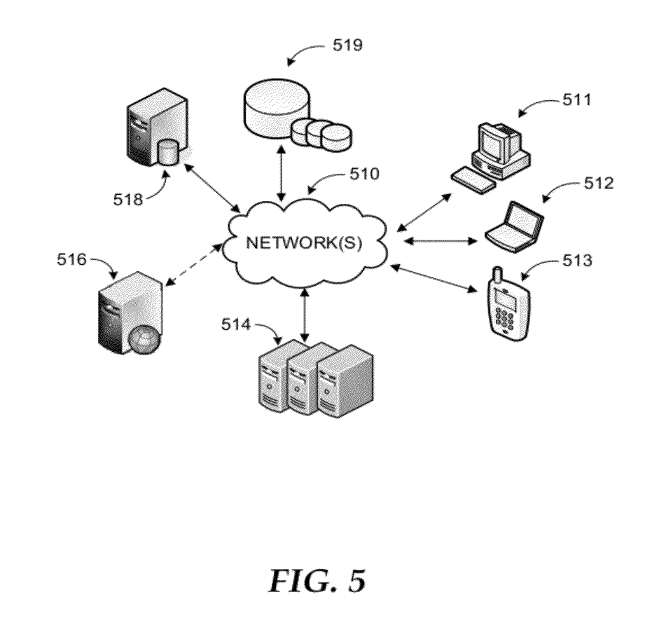

FIG. 5 is an example networked environment, where embodiments may be implemented. Source code customization by adding the event handlers to be invoked in metadata instead of as coding artifacts may be implemented via software executed over one or more servers 514 or a single server (e.g. web server) 516 such as a hosted service. The platform may communicate with client applications on individual computing devices such as a smart phone 513, a laptop computer 512, or desktop computer 511 (‘client devices’) through network(s) 510.

As discussed above, instead of defining events as coding artifacts, they may be modeled in metadata. The fact that the eventing is defined in metadata makes it possible to add and remove handlers for specific events without programming. In a networked environment, client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement source code customization through metadata based eventing. Furthermore, the networked environments discussed in FIG. 5 are for illustration purposes only. Embodiments are not limited to the example applications, modules, or processes.

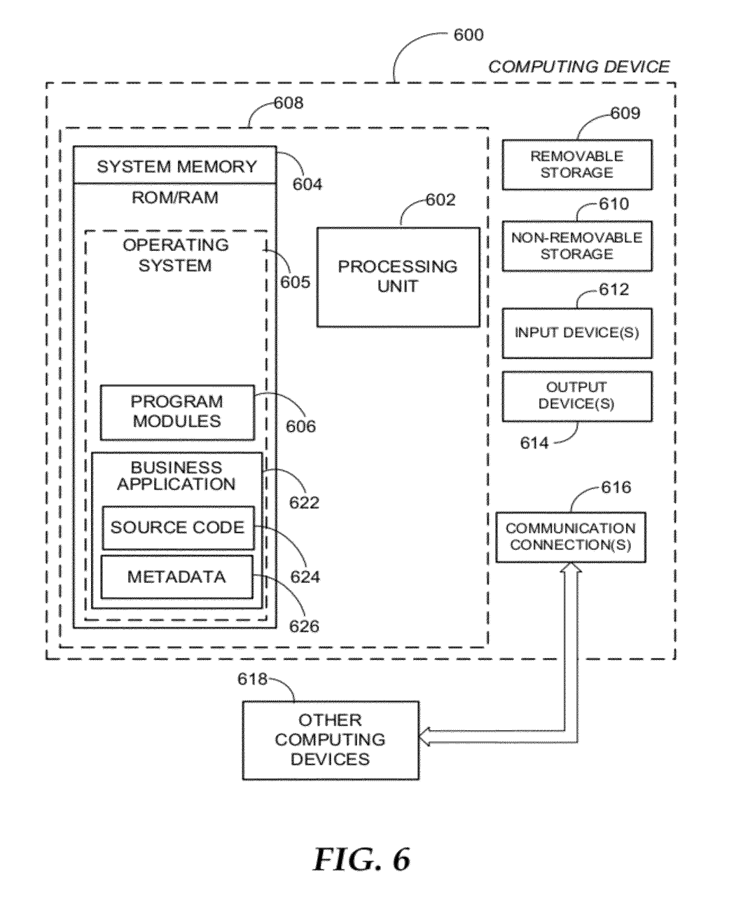

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing a software application and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, business application 622, with source code 624 and metadata 626.

Source code 624 of business application 622 may be customized by adding event handlers to be invoked in metadata 626 instead of as coding artifacts. By defining eventing in metadata 626 adding and/or removing handlers for specific events is enabled without programming, i.e., modification, of the source code 624. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, and includes any information delivery media. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

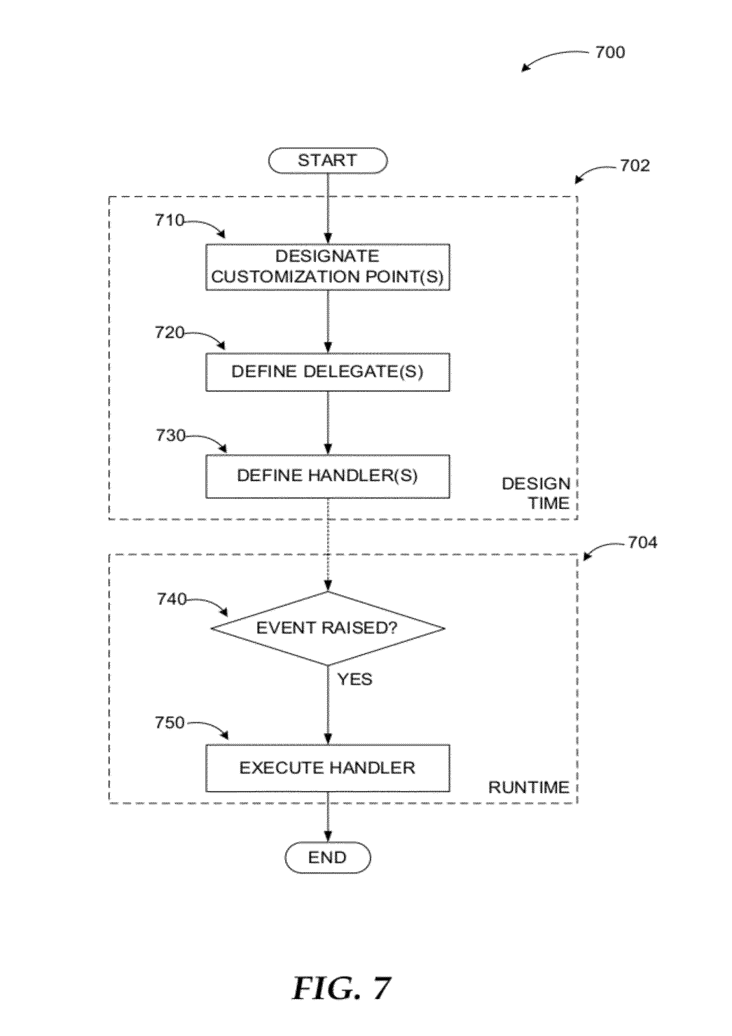

FIG. 7 illustrates a logic flow diagram for process 700 of using metadata based eventing for customizing source code according to embodiments. Process 700 may be implemented in any software application. In process 700, operations 710, 720, and 730 occur at design time 702, while operations 740 and 750 occur at runtime 704.

Process 700 begins with operation 710, where one or more customization points are designated in the source code of the software application. The customization points may be methods of the source code, for example. At operation 720, one or more delegates may be defined. Delegates are named type profiles that are to be matched by handlers for an event raised by the source code. At operation 730, one or more handlers associated with the delegate(s) may be defined. Handlers may be methods defined in metadata of the software application that are executed in response to an event being raised during the execution of the source code, enabling customization of the software application without modification of the source code.

At operation 740, a determination may be made during the execution of the source code whether an event is raised. An event may be raised by a statement of a method in the source code. If the event is detected, the associated handler(s) defined by the delegate may be executed at operation 750 before the execution of the program defined by the source code continues.

The operations included in process 700 are for illustration purposes. Source code customization through metadata based eventing according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device for source code customization through metadata based event handling, the method comprising:
designating at least one customization point associated with an event in the source code of a software program;
defining at least one delegate that is a named type profile to be matched by one or more handlers associated with an event defined at the customization point; and
enabling execution of at least one of the one or more handlers defined in metadata of the software program in response to the event being raised during execution of the source code.

2. The method of claim 1, wherein a class of the source code include one or more delegates and one or more methods.

3. The method of claim 2, wherein each delegate and method includes one or more named parameters of a predefined type.

4. The method of claim 2, wherein each handler is a method on a designated class.

5. The method of claim 1, wherein the customization point is a method in the source code.

6. The method of claim 1, further comprising:
enabling a customizing developer to one of add and remove a handler to the metadata for an event in the source code.

7. The method of claim 1, wherein the event is one of: a business event modeled in the metadata for business logic execution, a method event that is raised when a source code method is executed, and a data event that is raised in relation to a change in a database associated with the source code.

8. The method of claim 1, wherein the event is raised from a statement within a source code method.

9. The method of claim 1, wherein the at least one delegate is identified by a unique name within a list of methods and events for the source code.

10. The method of claim 1, wherein the at least one delegate includes a documentation comment including information associated with a circumstance of raising of the event and definition of at least one parameter associated with the event.

11. A computing device for executing a customizable software program, the computing device comprising:
a memory storing instructions;
a processor coupled to the memory, the processor executing the customizable software program in conjunction with the instructions stored in the memory, wherein the processor is configured to:
designate at least one customization point associated with an event in the source code of a software program;
define at least one delegate that is a named type profile to be matched by one or more handlers defined in metadata of the software program associated with an event defined at the customization point;
enable a customizing developer to one of add and remove a handler to the metadata for the event in the source code; and
enable execution of at least one of the one or more handlers in response to the event being raised during execution of the source code.

12. The computing device of claim 11, wherein the processor is further configured to:
provide a developer user interface that presents events and methods of the source code with the events listed as a separate set of methods.

13. The computing device of claim 12, wherein the processor is further configured to:
when an event is selected on the user interface, present at least one of a behavior and a property of the event.

14. The computing device of claim 12, wherein the processor is further configured to:
present the metadata as nodes with properties such that storage and retrieval of the metadata from a metadata database s enabled.

15. The computing device of claim 14, wherein the metadata includes a version for enabling upgrades in response to property set changes.

16. The computing device of claim 11, comprising one of a server, a desktop computer, a laptop computer, a handheld computer, a vehicle-mount computer, and a smart phone.

17. A computer-readable storage medium with instructions stored thereon for customizing a software program through metadata based event handling, the instructions comprising:
designating at least one customization point associated with an event in the source code of a software program, wherein the customization point is associated with a method;
defining at least one delegate that is a named type profile to be matched by one or more handlers defined in metadata of the software program associated with an event defined at the customization point;
enabling a customizing developer to one of add and remove a handler to the metadata for the event in the source code; and
enabling execution of at least one of the one or more handlers in response to the event being raised in response to a statement in the method during execution of the source code.

18. The computer-readable storage medium of claim 17, wherein the handler executed in response to the event being raised is a method defined in one of managed code and unmanaged code.

19. The computer-readable storage medium of claim 17, wherein the instructions further comprise:
presenting methods, events, and handlers associated with the software program in a graphical user interface as nodes in a structured diagram; and
presenting a context menu in response to selection of a node enabling a customizing developer to one of view and modify attributes and properties of the selected node.

20. The computer-readable storage medium of claim 19, wherein the context menu enables at least one from a set of: addition of a new handler, removal of an existing handler, duplication of an existing handler, and compilation of the selected handler.
